(19) United States
(12) Patent Application Publication
(10) Pub. No.: US 2004/0240618 A1
(43) Pub. Date: Dec. 2, 2004

(54) Multi-spectrum X-ray generation

(76) Inventor: Edward L. McGuire, Mountain View, CA (US)

Correspondence Address: KURT LEYENDECKER, 9241 S LARK SPARROW DR., HIGHLANDS RANCH, CO, 80126, US

(21) Appl. No.: 10/817,988

(22) Filed: Apr. 5, 2004

Related U.S. Application Data
(60) Provisional application No. 60/320,088, filed on Apr. 4, 2003.
(60) Provisional application No. 60/320,090, filed on Apr. 4, 2003.

(51) Int. Cl. H01J 35/00; H01J 35/22; H01J 35/32; H01J 35/30

(52) U.S. Cl. 378/137

(57) ABSTRACT

By arranging for a collection of different materials to be used as x-ray targets in a single x-ray generator tube, an X-ray generator that can transmit a collection of unique x-ray spectra is produced according to one embodiment of the present invention. Spectrum selection can be accomplished by electronic means (with great speed) by deflecting an electron beam by means of electric fields, magnetic fields, and any combination of the two.

### REFERENCE TO RELATED APPLICATION

This application claims priority to the provisional application No. 60/320,088 filed on 04.04.2003 entitled “Multi-spectrum x-ray generation”, and having one common inventor with this application. Further, the patent application no. ______ entitled, “Multi-spectral X-ray Image Processing” filed concurrently with this application, having the same inventor as this application, and claiming priority to a similarly named provisional application no. 60/320,090 filed on 04.04.2003 is incorporated herein in its entirety. Additionally, this application incorporates patent application no. 10/748961 entitled “Forward X-ray Generation”, which shares the one of the inventors with the present invention, in its entirety.

### FIELD OF THE INVENTION

The present invention relates generally to the generation of X-rays and more particularly to a device and method for the generation of multiple spectra (colors) of x-raysfrom a single x-ray generator tube.

### BACKGROUND

Generation of X-rays:

X-rays are generated whenever a beam of high energy electrons strikes a metallic anode. The material of the anode emits a spectrum of x-rays, consisting of two components: a line spectrum of radiation characteristic of the anode material struck by the high energy electrons (only whenever the voltage is over a certain threshold), and a continuous spectrum which depends only on the value of the high voltage which accelerated the electrons.

Characteristic Line Spectrum:

In conventional systems, the line spectrum is ignored or filtered out as much as possible, and only the continuous spectrum radiation is used.

The line spectrum is unique and depends on the nuclear mass of the anode material. For each mass in the periodic table there is a line spectrum. No lines are exactly the same: it is as individual as a fingerprint. Also, no material absorbs its own line spectrum: only another material can do that.

Anode Materials:

In conventional x-ray generators, although for heat dissipation purposes the anode may be composed of more than a single material, the electrons strike only a single anode material, therefore generating only a single characteristic line spectrum if any depending on the voltage level of the associated electron beam.

The Continuous X-ray Spectrum:

In conventional x-ray generators, the high voltage is substantially constant, and this causes the generation of a substantially constant continuous x-ray spectrum.

### SUMMARY OF THE INVENTION

In one preferred embodiment of the invention, an apparatus for generating high intensity X-rays is described. The apparatus comprises a source for generating a beam of electrons in combination with at least one deflection field adapted to direct the beam of electrons, and at least one anode assembly comprising a plurality of different anode materials. Each anode material has an electron beam strike surface.

In another preferred embodiment of the invention, a method of operating an X-ray generation device is described. The method comprises generating a beam of high energy elections, directing the beam to strike one of a plurality of different anode materials comprising an anode assembly, and directing a resultant x-ray beam at a body.

In yet another preferred embodiment of the invention, another method of operating an X-ray generation device is described. The method comprises selectively generating a plurality of electron beams of varying voltage levels by varying the input voltage to an electron beam source. Next, the electron beam is moved along an array of anode assemblies by applying at least one of an electric field and a magnetic field to the electron beam. After that, the electron beam is directed to one of a plurality of anode materials within each anode assemblies in the array by applying at least one of the electric field and the magnetic field to the electron beam. Finally, the resultant x-ray beam is directed at a body.

### BRIEF DESCRIPTION OF THE DRAWINGS

FIG. 1 is a simplified overall view of a multi-anode and multi-energy x-ray generator according to one embodiment of the present invention.

FIG. 2 shows a preferred embodiment of the present invention in which an anode assembly is comprised of a layer of anode material upon a layer of radiation absorbing material.

FIG. 3 shows a portion of another preferred embodiment anode assembly in which each anode layer is made up of a multiplicity of different anode materials.

FIG. 4 shows a preferred embodiment in which the anode assemblies are separated by a spacing element, which is located so the electron beam does not strike it in proper operation.

### DETAILED DESCRIPTION OF EMBODIMENT OF THE INVENTION

When a high energy electron beam strikes a metallic anode in an x-ray generator tube, a unique x-ray spectrum is emitted.

By arranging for a collection of different materials to be used as x-ray targets (anodes) in a single x-ray generator tube, a collection of unique x-ray spectra can be produced by a single tube.

Spectrum selection is accomplished by electronic means (with great speed) by deflecting the electron beam to strike selected metallic anode regions of different material by means of electric fields, magnetic fields, and any combination of the two.

Furthermore, spectrum modification can also be accomplished by electronics means (with great speed) by altering the high voltage used to produce the high energy electron beam. Because the characteristic line spectrum has a threshold voltage associated with each spectral line, it is possible to limit the number of radiation lines emitted by limiting the high voltage. Even the continuous radiation has a cutoff effect whereby no radiation can be emitted of shorter wavelength than that which corresponds to the high voltage. This effect allows the shortest wavelength emitted to be continuously and almost instantaneously controlled.

The Uniqueness of Characteristic Line Spectra:

Each anode material generates (and will not absorb) a characteristic line spectrum which cannot be mistaken for that of any other material. A heavier anode material will generate characteristic lines at shorter wavelengths, and a lighter anode material will generate characteristic lines at longer wavelengths. There are no unknown nuclear materials: the line spectra are all recorded.

Therefore, precision matching of a selected radiation spectrum with the absorption spectrum of particular anode materials allows absolutely unambiguous identification of those materials.

Multiple Anode Materials:

It is essential to be able to selectively generate the unique characteristic x-ray line spectra from a variety of anode materials in order to facilitate material identification. To identify a particular material, it can be necessary to generate x-rays from a heavier and a lighter material in order to make a sure identification. In order to carry out this process rapidly enough to be useful, the multiple selected anode materials are incorporated into a single x-ray generator tube according to one embodiment. Rapid selection is typically accomplished by deflection of the electron beam by electric fields, magnetic fields, or a combination of both.

Material Identification:

The identification of characteristic line spectra is unique. For example, it is possible to identify dangerous materials in air cargo containers and in luggage. Although material identification can be carried out by imaging methods in carry-on baggage, where there is little object overlap, and where the identification of materials has timely importance, the identification can be carried out on large cargo containers without performing any imaging analysis, just by performing a spectral analysis, recognizing the lines. Non-imaging systems can alarm upon detecting the characteristic line spectra of controlled substances such as lead, arsenic, uranium, plutonium, etc.

Dental patients may have a variety of metals in their mouths, and each can be separately identified, even to the point of discriminating between different fillings made by different dentists using different alloys or metal mixtures.

Patients in emergency surgery to remove bullets can already have other metal objects inside them which their health continues to depend upon. Being able to precisely identify the metals is critical.

Selected Energy Continuous Spectra:

If an otherwise conventional x-ray generator were operated at selected differing high voltages, this would cause the generation of selected differing continuous x-ray spectra. The differing spectra would suffer different absorption effects in passing through an unknown body, enabling discrimination of the atomic composition of the unknown body. This identification can be carried out in addition to conventional imaging analysis, revealing further information about the objects in the viewed image.

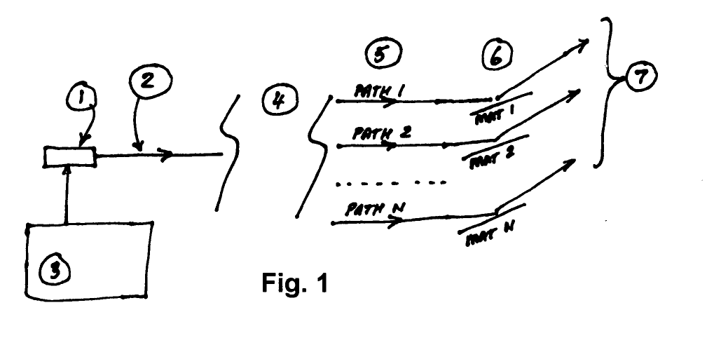

In FIG. 1, materials selected for use as anodes of the multi-spectrum x-ray generator are arranged so that they can be struck by a high energy electron beam (2) from a source of high energy electrons (1) whose energy is controlled by a high voltage power supply (3).

The path of the beam of high energy electrons (2) is deflected in region (4) by means of magnetic fields, electric fields, or a combination of magnetic and electric fields (hereinafter, “deflection fields”) being applied to the beam (2) in region (4).

The deflection of the beam (2) results in the beam taking a multiplicity of different paths (5) striking different selected anode materials (6) and causing them to emit different selected characteristic line and continuous spectrum radiation.

FIG. 1 shows a preferred embodiment in which deflection fields are applied to beam (2) in region (4) in two transverse axes such that different anode assemblies in different locations are selected by one deflection means (hereinafter, the “scan axis”), and different portions of a given anode, having different materials in different areas upon it, (hereinafter, the “material axis”) are selected by the other deflection means.

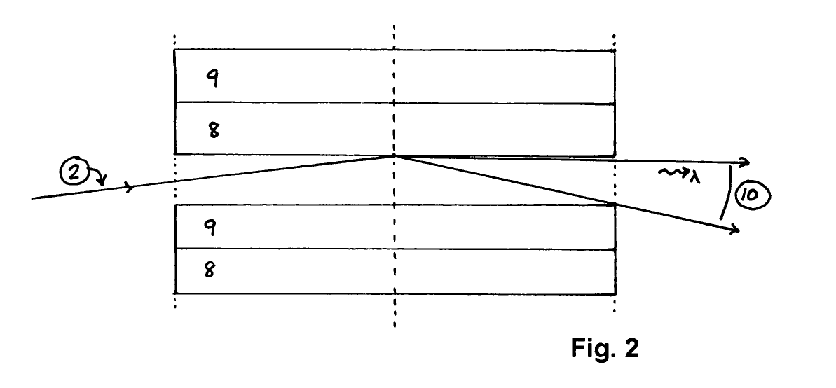

FIG. 2 shows a preferred embodiment in which an anode assembly is comprised of a layer of anode material (8) upon a layer of radiation absorbing material (9).

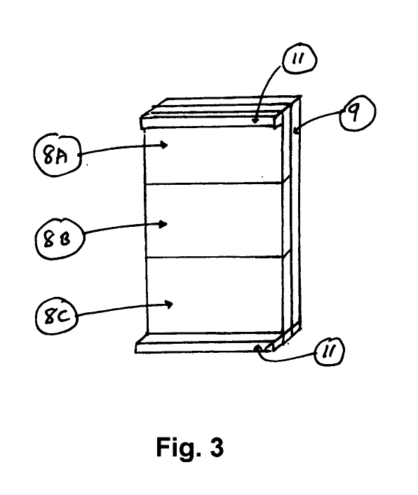

FIG. 3 shows a portion of another preferred embodiment anode assembly in which each anode layer is made up of a multiplicity of different anode materials.

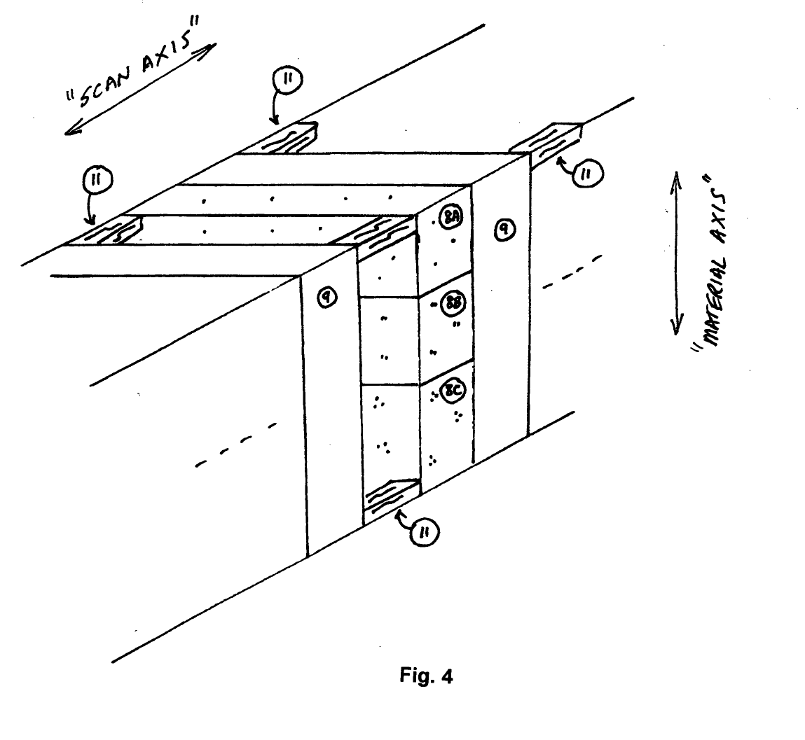

FIG. 4 shows a preferred embodiment in which the anode assemblies are separated by a spacing element (11), which is located so the electron beam does not strike it in proper operation.

Referring to FIG. 2, the electron beam is directed to enter between the repeating elements (8) plus (9), and to strike anode material (8). The resulting fan beam of x-ray radiation (10) is limited in angular extent by the layer of anode material (8) and the layer of radiation absorbing material (9).

### OPERATION OF ONE EMBODIMENT OF THE INVENTION

In FIG. 1, a source of high energy electrons (1) produces a beam of high energy electrons (2) which is accelerated by a variable high voltage power supply (3).

The path of the beam of high energy electrons (2) is deflected in region (4) by means of deflection fields that are applied to the beam (2) in region (4).

In FIG. 1, materials selected for use as anodes of the multi-spectrum x-ray generator are arranged so that they can be struck by the electron beam (2).

The deflection of the beam (2) results in the beam taking a multiplicity of different paths (5) striking different selected anode materials (6) and causing them to emit different selected characteristic line and continuous spectrum radiation.

FIG. 1 shows a preferred embodiment in which deflection fields are applied to beam (2) in region (4) in two transverse axes such that different whole anode assemblies in differing locations are selected by the “scan axis”, and different portions of a given anode (selectively) i.e. the “material axis”, having different materials in different areas upon it.

The deflection means along the “scan axis” selects the location along a line-of-scan from which radiation will be emitted, and the deflection means along the “material axis” selects the type of anode material which will be struck by the electron beam.

The high voltage power supply is designed to be capable of extremely rapid variations, changing from one high voltage setting to any other in a period of time so short as to appear instantaneous in comparison with the physical beam deflection along the “scan axis” direction. The deflection systems are each designed so as to perform their positioning independently from any high voltage variations.

Wherever the beam strikes an anode material, the spectral characteristics of the radiation emitted can be controlled by variation of the high voltage power supply.

One effect of high voltage control is on the characteristic line spectrum which may be emitted from a given anode material. The characteristic line spectrum of any material has a number of particular wavelengths, called lines. Each line has a precise high voltage value, in kilovolts, associated with it. Only when the high voltage energy of the electron beam exceeds this value is that particular line in the spectrum emitted. If the high voltage is very high, several lines may simultaneously be emitted. Below a certain base threshold, no lines whatever are emitted. The kilovolt values for all lines of all materials are known and published, so exact control is possible.

Another effect of high voltage control is on the continuous or “white light”-like spectrum which is emitted by all anode materials. A significant feature of this type of x-ray emission is that the spectrum is truncated at the short wavelength end, at a wavelength which corresponds to the high voltage energy of the electron beam. No shorter wavelengths of radiation are emitted. When the high voltage varies, the short wavelength cutoff varies. This effect does not depend upon the anode material.

FIG. 2 shows a preferred embodiment in which an anode assembly is comprised of a layer of anode material (8) upon a layer of radiation absorbing material (9). These layers are not necessarily planar, and incorporation of a curvature in their shape can increase the radiation being emitted in a desired direction.

FIG. 3 shows a preferred embodiment in which each anode layer is made up of a multiplicity of different anode materials, in this embodiment: three (8A), (8B) and (8C). In this embodiment, as shown in FIG. 3, the “material axis” is vertical, or up-and-down the anode assembly (8A+8B+8C). In FIG. 3, the “scan axis” is horizontal.

FIG. 4 shows a preferred embodiment in which the anode assemblies are separated by a spacing element (11), which is located so the electron beam does not strike it in proper operation.

Referring to FIG. 2, the electron beam is directed to enter between the repeating elements (8) & (9), and to strike anode material (8). The resulting fan beam of x-ray radiation (10) is limited in angular extent by the layer of anode material (8) and the layer of radiation absorbing material (9).

Although the deflection of the electron beam along the “scan axis” may be continuous with respect to time, the emission of x-rays would be periodic, since only when the beam enters between the repeating elements (8)+(9) is radiation emitted. The use of thin repeating elements (8) & (9) will allow the pulses of radiation to be rapid and the individual source locations to appear continuously distributed. In the case of a statically deflected electron beam along the “scan axis”, the emission of x-rays would, of course, be continuous from each position selected.

In a preferred embodiment, the source (1) of FIG. 1 can include a “triode gun”, which enables the beam of electrons to be controlled in intensity, and interrupted completely at any time, as may be advantageous-to the operation of the x-ray tube. Cutting off the electron beam completely could aid in keeping the beam from hitting the spacing element (11) of FIG. 3 which could cause undesired radiation or other effects.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

We claim:

1. An apparatus for generating high intensity X-rays comprising:
a source for generating a beam of electrons;
at least one deflection field adapted to direct the beam of electrons; and
at least one anode assembly comprising a plurality of different anode materials, each anode material having an electron beam strike surface.

2. The apparatus of claim 1, further including a selectively variable high voltage power supply, wherein the source generates beams of electrons having differing voltages depending on the voltage input into the source from the power supply.

3. The apparatus of claim 1, wherein the at least one deflection field comprises a magnetic field.

4. The apparatus of claim 1, wherein the at least one deflection field comprises an electric field.

5. The apparatus of claim 1, wherein the at least one anode assembly comprises a plurality of anode assemblies and the at least one deflection field is adapted to both (i) move the beam of electrons along a scan axis between the plurality of anode assemblies, and (ii) direct the beam of electrons to a particular anode material of the plurality of anode materials within a single anode assembly along a material axis.

6. The apparatus of claim 5, wherein each anode assembly of the plurality of anode assemblies comprises a similar set of different anode materials.

7. The apparatus of claim 5, wherein each anode assembly of the plurality of anode assemblies comprises a different set of different anode materials.

8. The apparatus of claim 1, wherein the at least one anode assembly comprises an x-ray generator tube.

9. The apparatus of claim 2, wherein the power supply is adapted to nearly instantaneously change from one voltage output to another voltage output.

10. The apparatus of claim 2, wherein control and operation of the power supply, and the one or more deflection fields are independent of one another.

11. A method of operating an X-ray generation device, the method comprising:
generating a beam of high energy elections;
directing the beam to strike one of a plurality of different anode materials comprising an anode assembly; and
directing a resultant x-ray beam at a body.

12. The method of claim 11, wherein said generating a beam of high energy electrons further includes selectively varying the voltage of the beam of high energy electrons.

13. The method of claim 11, wherein said directing the beam further comprises moving the beam using one of a magnetic field and an electric field.

14. The method of claim 13, wherein said directing the beam further comprises one or both of (i) moving the beam along a first axis to direct the beam at one of a plurality of anode materials within a single anode assembly and (ii) moving the beam along a second axis between a plurality of anode assemblies to provide a scanning x-ray beam.

15. The method of claim 11, wherein said directing a resultant x-ray beam at a body comprises scanning one of an airline cargo hold, a ship container, a train car and an over-the-road trailer.

16. The method of claim 11, wherein said directing a resultant x-ray beam at a body comprises scanning airline luggage.

17. The method of claim wherein said directing a resultant x-ray beam at a body further comprises directing a plurality of resultant x-ray beams at the body, wherein each x-ray beam has a different line spectra signature.

18. A method comprising:
selectively generating a plurality of electron beams of varying voltage levels by varying the input voltage to a electron beam source;
moving the electron beam along an array of anode assemblies by applying at least one of an electric field and a magnetic field to the electron beam;
directing the electron beam to one of a plurality of anode materials within each anode assemblies in the array by applying at least one of the electric field and the magnetic field to the electron beam; and
directing the resultant x-ray beam at a body.

19. The method of claim 18, further comprising determining the composition of the body by analyzing the x-ray radiation reflected off of the body relative to the spectra of the x-ray beam striking the body.

20. The apparatus of claim 1 wherein the source comprises a triode gun.
